(19) United States
(12) Patent Application Publication
(10) Pub. No.: US 2009/0144563 A1
(43) Pub. Date: Jun. 4, 2009

(54) Method of detecting data tampering on a storage system

(76) Inventors: Jorge Campello De Souza, Cupertino, CA (US); Richard M.H. New, San Jose, CA (US)

Correspondence Address: MARLIN KNIGHT, P. O. BOX 1320, PIONEER, CA, 95666, US

(21) Appl. No.: 11/998,747

(22) Filed: Nov. 30, 2007

(51) Int. Cl. G06F 12/14

(52) U.S. Cl. 713/193

(57) ABSTRACT

A storage system according to the invention maintains an arithmetic signature or fingerprint generated using the content of selected units of data stored on the media. The signature is stored in metadata in non-volatile storage on the system's electronics card preferably in a tamper resistant module (TRM). When reading a data unit from storage, the system uses the saved signature to verify that the data unit has not been altered by unauthorized means after it was stored. The content of the stored data is thereby bound to the metadata stored in the system's non-volatile storage so that by-passing or physically separating the bulk storage media (e.g. disks) from the system's electronics will not allow alteration of the data without detection. The method also prevents unauthorized data roll-back because the signature of old data will not match the current signature in the metadata.

### FIELD OF THE INVENTION

The invention relates to methods and systems for detecting unauthorized alterations of data stored on a storage system such as a disk drive.

### BACKGROUND

The typical hard disk drive (HDD) used in computers is not tamper resistant. With current HDD architecture, an attacker with physical access can probe the electronics card and its interconnects; remove the electronics card and replace it with custom electronics; and/or physically remove the disks on which information is recorded. Physical access to the device allows an attacker to defeat some security measures and may even allow data to be altered in a manner that is undetectable to users. Making HDDs resistant to physical tampering would be expensive, as well as, requiring significant changes in the manufacturing process.

One method of protecting stored data uses encryption. Key encryption methods include, DES (Data Encryption Standard) and AES (Advanced Encryption Standard) and RSA a public key encryption method. Although the user application or host system can perform the encryption, the encryption and decryption can also be performed in the storage device hardware in a way that is transparent to the user. For example, the LRW-AES method is “tweakable” block cipher for encryption of stored data. It can protect each 16-byte narrow block. LRW-AES uses a secret AES key, a secret 16 byte secondary key, and a 16-byte tweak generated from the secondary key and the logical position of the block. The tweak value is computed from the logical position of the current narrow block within the scope of the current key. The application for LRW-AES is encryption of storage at the sector level. It addresses threats such as copy-and-paste attacks and dictionary attacks.

Unauthorized reading of data is one risk, but alteration of data is also possible. Some types of alteration result in gross loss of data which can at least be easily detected. More problematic are alterations that are difficult to detect such as data roll-back attacks in which the data is restored to a previously valid state through unauthorized tampering. In a roll-back attack the system may appear to be a normal, valid condition, but new data acquired since the rollback checkpoint will have been lost. Encryption alone does not prevent roll back of the data to a previously good state if the encryption keys are the same for the old and updated data.

In published application 20020152396 (Oct. 17, 2002), Fox, et al. describe the use of duplicate databases with authentication codes to deter a rollback attack against a database. When the second database is not corrupted, the method recalculates the second authentication code using a portion of the first authentication code and copies the second database over the first database. This solution is expensive in that it requires a complete redundant copy of the database. Moreover, it is not applicable to individual storage device design.

In published application 20050044401 (Feb. 24, 2005) Morrow, et al. describe a rollback attack prevention method for a gaming machine that uses a configuration log and a revocation list. The configuration log includes a protected record of software that has been installed on the gaming machine. The revocation list includes an inventory of unauthorized software that the prevention system prevents from being installed and/or used on the gaming machine.

In published application 20070185902 (Aug. 9, 2007) Messinger, et al. describe an object-based data storage device with multiple media zone attributes of storage performance. The storage device receives an object from the host system that has a requested storage attribute attached to the object. The storage device comprises an object-based storage interface that couples between the data channel and the storage media. The object-based storage interface schedules the object for storage in a selected zone of the multiple media zones based on the attributes and requested attributes.

In published application 20070156763 (Jul. 5, 2007) Liu, et al. describe a storage management system that includes a file system server, a metadata server, and an object storage device (OSD). The file system server is used for accessing a file through a virtual partition. The metadata server is used for storing the metadata of the accessed file. When a file is accessed, the file system server transmits a command of accessing the partition to the metadata server and performs the file accessing operation to the OSD through the metadata of the accessed file transmitted back by the metadata server.

Although various schemes allow hosts to detect unauthorized rollbacks, there is a need to detect such data roll-back attacks at the device level.

### SUMMARY OF THE INVENTION

A storage system according to the invention maintains an arithmetic signature or fingerprint generated using the content of selected units of data stored on the media. The signature is stored in metadata in non-volatile storage on the system's electronics card preferably in a tamper resistant module (TRM). When reading a data unit from storage, the system uses the saved signature to verify that the data unit has not been altered by unauthorized means after it was stored. The content of the stored data is thereby bound to the metadata stored in the system's non-volatile storage so that by-passing or physically separating the bulk storage media (e.g. disks) from the system's electronics will not allow alteration of the data without detection. The method also prevents unauthorized data roll-back because the signature of old data will not match the current signature in the metadata even though it is otherwise consistent with the system's architecture.

The invention can be used with any type of data units including user-defined objects, files, tables, sectors and/or any other distinguishable unit. More than one type of data unit can be used. The units can also be defined by the drive in a way that is transparent to the user. A storage system according to an embodiment of the invention could maintain internal definitions of data units such as sectors, blocks, tracks, etc. However, the process is more efficient if the data units are relatively large as is typically the case for user-defined files, rather than at the sector level.

When a data unit is created or updated, the system creates the electronic signature as a function of the content of the data. Any prior art method for creating arithmetic signatures, such as CRCs, hash codes, etc., can be used with the invention. The arithmetic signature for each data unit is stored in a separate trusted storage region of non-volatile memory on the electronics card. Each data unit is preferably encrypted before being written on the media. As part of the read back process, in one embodiment the system computes a new signature using the data unit read from the media and compares that new signature with the one previously stored in the metadata. If the two signatures do not match, an error is reported to the host.

The signature can also optionally be concatenated to the data unit to form a system object which is then encrypted and stored on the system's media. In this embodiment when the system object is read back, the system first decrypts the system object and then verifies the signature of the data unit by comparing it with the stored electronic signature on the electronics card. If the signatures do not match, the system will report an error.

Preferably bulk encryption of data units and/or system objects is used with keys stored in the TRM on the electronics card. Bulk encryption protects the data on the disks from being read in the event that the disks are removed from the system because the keys will remain protected on the electronics card.

### BRIEF DESCRIPTION OF THE FIGURES

FIG. 1 is a block diagram illustrating a storage system according to an embodiment of the invention.

FIG. 2 is a block diagram illustrating a system object according to an embodiment of the invention.

FIG. 3 is a flowchart of a method according to the invention for creating a system object from a data unit and an appended signature.

FIG. 4 is a flowchart of a method according to the invention for updating a user-defined object that is stored without an appended signature.

### DETAILED DESCRIPTION OF THE INVENTION

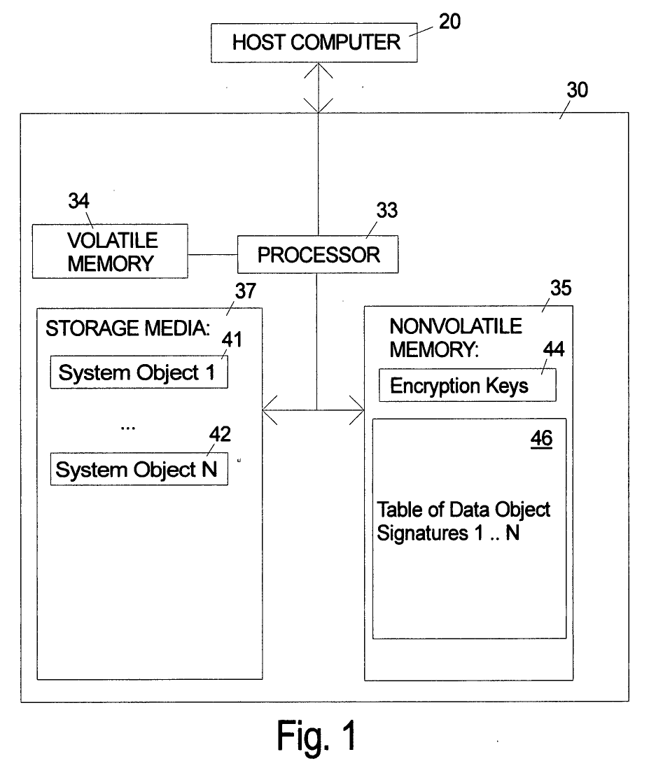

FIG. 1 is a block diagram illustrating selected components in a storage system 30 according to an embodiment of the invention. The invention can be used with any type of storage media 37 including magnetic, optical and opto-magnetic. Information, commands, data, etc. flow back and forth between the host computer 20 and the storage system 30 through a communications interface which can be any hardware interface including any of the prior art interfaces currently in use. The storage system includes a microprocessor 33 which accesses both volatile memory 34 and nonvolatile memory 35. When the system is operating the program code for the microprocessor 33 can be stored in either the volatile memory 34 or nonvolatile memory 35, but the program code must originate in some form of nonvolatile memory, for example, in the form of a preprogrammed device such as an EEprom (not shown). At power-up time the system must contain at least a bootstrap program that allows basic functions to be performed to read from the disk and communicate with a host. After initialization additional program code can be read from the bulk storage media or downloaded from the host computer 20. Storage media 37 is the nonvolatile bulk storage media such as disks with coatings that include thin film magnetic materials. Storage media 37 will typically have a much higher capacity than nonvolatile memory 35. The invention stores at least some of the data on the storage media 37 in the form of system objects 41, 42 that have corresponding signatures stored in nonvolatile memory 35. A system object includes a data unit and optionally the signature for the data unit. The nonvolatile memory 35 is preferably a tamper resistant module (TRM). Nonvolatile memory 35 also holds encryption/decryption keys 44 and a table of signatures 46 corresponding to the data units 1 . . . N that are encoded in system objects 1 . . . N. In this embodiment the signatures are shown stored in a table 46, but any method of storing the signature in an organized manner allowing retrieval can be used such as linked lists, hash tables, etc.

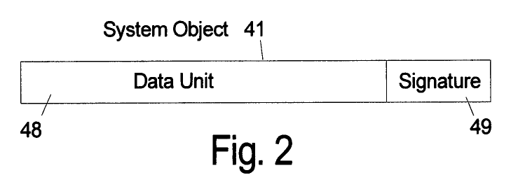

FIG. 2 is a block diagram illustrating a system object 41 according to an embodiment of the invention. System object 41 is comprised of data unit 48 and signature 49. A signature of a unit of data according to the invention can be formed using any type of arithmetic function that uses a variable length string of data to compute a unique compact numerical value that is reasonably indicative of the data. Examples include checksums, CRC, hash codes, etc. Although each string of data will produce only one signature, more than one string of data can produce any given signature. The signature function should be selected using prior art techniques to have an acceptably low probability of generating the same signature from two different strings of data.

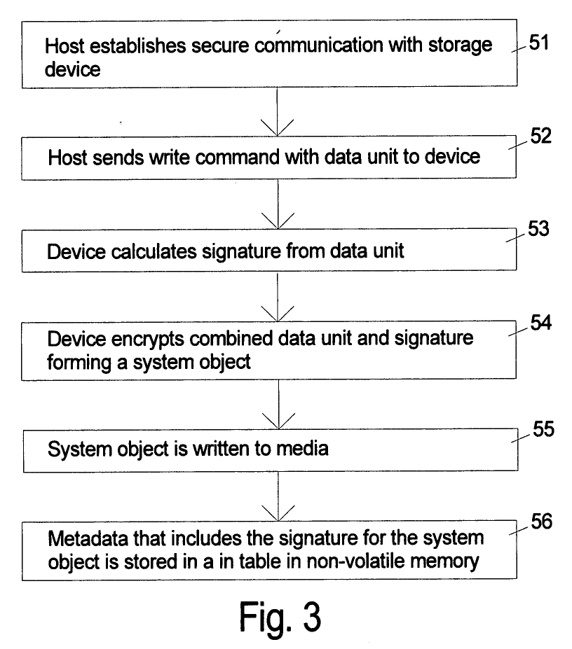

FIG. 3 is a flowchart of a method according to the invention for creating a data unit that is stored with an appended signature in a system object. The host establishes a secure (encrypted) channel with the storage system using standard prior art protocols 51. The host sends a write command that includes the data unit 52. The storage system computes the signature for the data unit 53. The data unit can be any unit of storage including user defined files, tables, objects or system defined blocks of storage. The combined signature and data unit are encrypted to form a system object 54. The system object is written to the storage media 55. The storage system stores the signature in the non-volatile memory table of system objects 56. Optionally, the storage system can use prior art journaling techniques to ensure that writing the system object on the media and the updating of the signature in the table of system objects are performed together atomically.

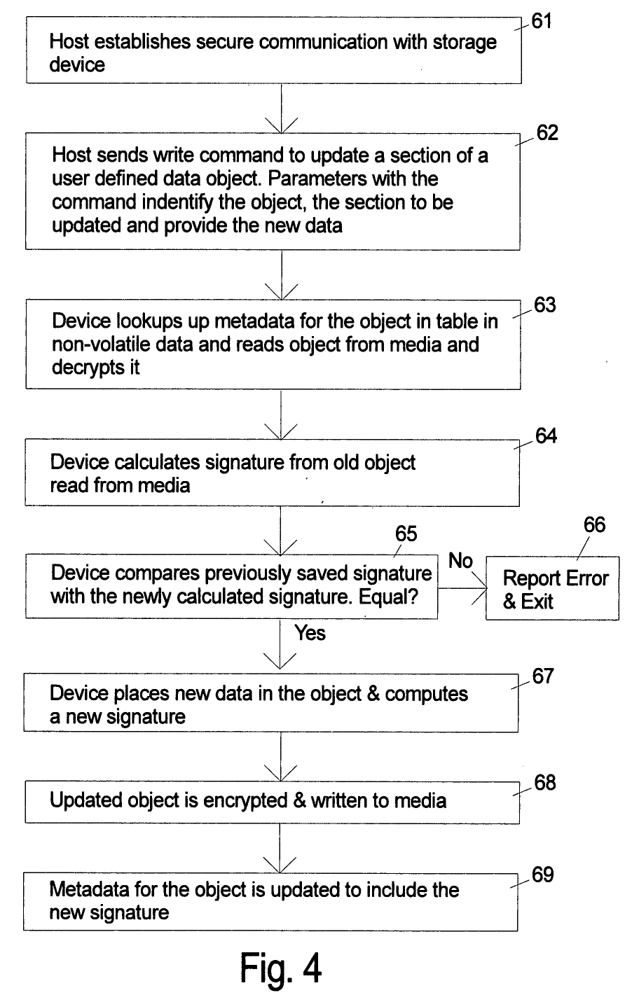

FIG. 4 is a flowchart of a method according to the invention for updating a user-defined object that is stored without an appended signature. The host establishes a secure (encrypted) channel with the storage system using standard prior art protocols 61. The host sends a write command that includes the object name/identifier, the position or offset address for the update, and new data to the storage system 62. The storage system looks up the object in the metadata in non-volatile memory which includes the previously stored signature for the object 63. The storage system reads the previously stored (old) user-defined object to be modified from the media and decrypts it 63.

The signature for the old object as read from the media is computed 64. The system retrieves the previously stored signature for the object from metadata in non-volatile memory and compares the computed signature to the stored signature 65. If the two signatures do not match, then the system sends an error message to the host indicating that the mismatch has been found and exits 66. If the two signatures are the same, the storage system replaces the section of the object at the specified position/offset with the new data and computes a new signature 67. The updated object is then encrypted, and the encrypted data is written back to the storage media 68. The storage system stores the new signature in the non-volatile memory table of user defined objects 69.

Optionally, the storage system can use prior art journaling techniques to ensure that the updating of the object on the media and the updating of the signature in the non-volatile memory table of user defined objects are performed together atomically.

The invention has been described with reference to specific embodiments, but one of ordinary skill in the art will readily recognize variations to the embodiments and those variations are within the spirit and scope of the present invention.

1. A method of operating a storage system comprising:
a) executing a write command by:
calculating a first signature as a predetermined arithmetic function of a first data unit;
storing in non-volatile memory in an electronic module in the storage system the first signature in metadata associated with the first data unit; and
writing the first data unit on a storage media; and
b) executing a command requiring reading the first data unit by:
reading the first data unit from the storage media;
calculating a second signature as a predetermined arithmetic function of the first data unit read from the storage media; and
reporting an error if the first and second signatures do not match.

2. The method of claim 1 further comprising encrypting the first data unit, before the step of writing the first data unit on a storage media, using a key stored in the non-volatile memory in the electronic module in the storage system.

3. The method of claim 1 wherein executing a command requiring reading the first data unit further comprises receiving an identifier for a user-defined object from a host and using the identifier to retrieve metadata including the first signature.

4. A method of operating a storage system comprising:
a) executing a write command by:
calculating a first signature as a predetermined arithmetic function of a first data unit;
storing in non-volatile memory in an electronic module in the storage system the first signature in metadata associated with the first data unit;
combining the first signature and the first data unit to form a first system object;
encrypting the first system object;
writing the encrypted first system object on a storage media; and
b) executing a command requiring reading the first data unit by:
reading the encrypted first system object from the storage media;
decrypting the first system object to retrieve the first data unit and the first signature as stored on the media;
comparing the first signature as stored on the media with the first signature as stored in the metadata; and
reporting an error if the first signature as stored on the media with the first signature as stored in the metadata do not match.

5. The method of claim 4 wherein encrypting the first system object uses a key stored in the non-volatile memory in the electronic module in the storage system.

6. The method of claim 4 wherein executing a command requiring reading the first data unit further comprises receiving an identifier for a user-defined object from a host and using the identifier to retrieve metadata including the first signature.

7. A storage system comprising:
a bulk storage medium with a first data unit stored therein;
a non-volatile memory component included in electronics;
a first signature stored in the non-volatile memory component that is arithmetically derived from the first data unit when the first data unit is stored on the bulk storage medium; and
means for reading the first data unit bulk storage medium that compares the first signature stored in the non-volatile memory component with a second signature that is stored with the first data unit on bulk storage medium or that is calculated using the first data unit as read from the bulk storage medium and reports an error if the first and second signatures are not equal.

8. The storage system of claim 7 wherein the first data unit stored on the bulk storage medium is encrypted and a key for decryption is stored in the non-volatile memory component.

9. The storage system of claim 7 wherein the first data unit is stored on bulk storage medium in a system object that includes the first signature and the system object is encrypted and a key for decryption is stored in the non-volatile memory component.
